(19) United States
(12) Patent Application Publication
(10) Pub. No.: US 2025/0285353 A1
(43) Pub. Date: Sep. 11, 2025

(54) METHOD FOR CONTROLLING AVATAR, AND ELECTRONIC DEVICE THEREFOR

(71) Applicant: Samsung Electronics Co., Ltd., Suwon-si (KR)

(72) Inventors: Joonsoo KIM, Suwon-si (KR); Kwanghyuk KIM, Suwon-si (KR); Ilwoo KWON, Suwon-si (KR)

(21) Appl. No.: 19/217,584

(22) Filed: May 23, 2025

Related U.S. Application Data
(63) Continuation of application No. PCT/KR2023/016536, filed on Oct. 24, 2023.

(30) Foreign Application Priority Data
Nov. 25, 2022 (KR) 10-2022-0160730

(51) Int. Cl. G06T 13/40; G06F 3/01

(52) U.S. Cl. CPC G06T 13/40; G06F 3/014; G06F 3/017

(57) ABSTRACT

An electronic device may include a communication interface, a memory storing one or more instructions, and at least one processor configured to execute the one or more instructions, wherein the at least one processor may be configured to execute the one or more instructions to obtain sensing information for controlling an avatar from a plurality of external devices corresponding to body parts, through the communication interface, determine action information indicating an action that is implementable in relation to a corresponding body part, based on the sensing information, and control the avatar, based on the determined action information.

### CROSS-REFERENCE TO RELATED APPLICATIONS

This application is a continuation application of International Application No. PCT/KR2023/016536 designating the United States, filed on Oct. 24, 2023, in the Korean Intellectual Property Receiving Office and claiming priority to Korean Patent Application No. 10-2022-0160730, filed on Nov. 25, 2022, the disclosures of which are all hereby incorporated by reference herein in their entireties.

### TECHNICAL FIELD

Various example embodiments may relate to a method of controlling an avatar, and/or an electronic device for performing the method.

### BACKGROUND ART

An avatar is a virtual graphical object that represent a user in the real world, and may be, for example, a two-dimensional (2D) icon or a three-dimensional (3D) model. An avatar may be something as simple as a photo of a user, or may be a graphical object capable of representing the user's appearance, facial expressions, activities, interests, or personality. An avatar may also be expressed as an animation.

Avatars are widely used in games, social network services (SNSs), messenger application services, health applications, or exercise applications. Avatars used in games or SNSs are created and changed according to the purposes of services provided by applications. An avatar in a game or SNS is not related to a user's appearance, posture, or facial expression or is similar to the user, but is provided with a function of changing its appearance as desired by the user. For example, games or SNSs provide a function of customizing avatars with clothing, accessories, items, etc.

To use metaverse and augmented reality (AR) services, avatars that can be controlled in detail may be advantageous in providing experiences similar to reality. In order to provide users with a realistic experience, there is a need to provide avatars capable of reflecting the user's characteristics or reflecting, in detail, the user's intended actions.

### SUMMARY

To address one or more of the above-described technical problems, certain example embodiments may provide an electronic device for controlling an avatar. An electronic device in certain example embodiments may include a communication interface comprising interface circuitry, a memory, and at least one processor comprising processing circuitry. The memory may store one or more instructions. The at least one processor may execute the one or more instructions. The at least one processor may individually and/or collectively execute the one or more instructions to obtain sensing information for controlling the avatar from a plurality of external devices corresponding to body parts, through the communication interface. The at least one processor may individually and/or collectively execute the one or more instructions to determine action information indicating an action that is implementable in relation to a corresponding body part, based on the sensing information. The at least one processor may individually and/or collectively execute the one or more instructions to control the avatar, based on the determined action information.

A method of controlling an avatar may be provided. The method may include obtaining sensing information for controlling the avatar from a plurality of external devices corresponding to body parts. The method may include determining action information indicating an action that is implementable in relation to a corresponding body part, based on the sensing information. The method may include controlling the avatar, based on the determined action information.

To address the above-described technical problems, according to another embodiment of the present disclosure provides a computer-readable recording medium having recorded thereon a computer program.

### BRIEF DESCRIPTION OF DRAWINGS

The present disclosure may be readily understood by reference to the following detailed description and the accompanying drawings, in which reference numerals refer to structural elements.

FIG. 1 is a conceptual view of an operation, performed by an electronic device according to an example embodiment, of controlling an avatar.

FIG. 2 is a conceptual view illustrating an operation of controlling an avatar, based on action information output according to an action information determination algorithm, according to an example embodiment.

FIG. 3 is a conceptual view for explaining respective roles of subjects played to control an avatar, according to an example embodiment.

FIG. 4 is a flowchart of a method, performed by an electronic device, of controlling an avatar, according to an example embodiment.

FIG. 5 is a conceptual view for explaining a method, performed by an electronic device worn by a user, for guiding a user's action by controlling an avatar, according to an example embodiment.

FIGS. 6 and 7 are conceptual views illustrating an operation, performed by an electronic device worn by a user, of controlling an avatar, according to an example embodiment.

FIGS. 8 and 9 are conceptual view illustrating an operation, performed by an electronic device, of controlling an avatar by receiving a signal from one or more external devices, according to an example embodiment.

FIG. 10 is a flowchart of a method, performed by an electronic device, of controlling an avatar, according to an example embodiment.

FIG. 11 is a conceptual view of an operation, performed by an electronic device according to an example embodiment, of controlling an avatar.

FIG. 12 is a block diagram for explaining an operation, performed by an electronic device according to an example embodiment, of converting sensing information received from an external device.

FIG. 13 is a block diagram of an electronic device according to an example embodiment.

### DETAILED DESCRIPTION

Although general terms widely used at present were selected for describing the present disclosure in consideration of the functions thereof, these general terms may vary according to intentions of one of ordinary skill in the art, case precedents, the advent of new technologies, or the like. Terms arbitrarily selected by the applicant of the present disclosure may also be used in a specific case. In this case, their meanings need to be given in the detailed description of an embodiment of the present disclosure.

An expression used in the singular may encompass the expression of the plural, unless it has a clearly different meaning in the context. Unless otherwise defined, all terms (including technical and scientific terms) used herein have the same meaning as commonly understood by one of ordinary skill in the art to which this disclosure belongs.

The terms “comprises” and/or “comprising” or “includes” and/or “including” used herein specify the presence of stated elements, but do not preclude the presence or addition of one or more other elements. The terms “unit”, “-er (-or)”, and “module” when used in this specification refers to a unit in which at least one function or operation is performed, and may be implemented as hardware, software, or a combination of hardware and software.

The expression “configured to (or set to)” used herein may be used interchangeably with, for example, “suitable for”, “having the capacity to”, “designed to”, “adapted to”, “made to”, or “capable of”, according to situations. The expression “configured to (or set to)” may not only necessarily refer to “specifically designed to” in terms of hardware. Instead, in some situations, the expression “system configured to” may refer to a situation in which the system is “capable of” together with another device or component parts. For example, the phrase “a processor configured (or set) to perform A, B, and C” may refer to a dedicated processor (such as an embedded processor) for performing a corresponding operation, or a generic-purpose processor (such as a central processing unit (CPU) or an application processor (AP)) that can perform a corresponding operation by executing one or more software programs stored in a memory.

When an element (e.g., a first element) is “coupled to” or “connected to” another element (e.g., a second element), the first element may be directly coupled to or connected to the second element, or, unless otherwise described, a third element may exist therebetween. Thus, “connected” as used herein covers both direct and indirect connections.

In the present disclosure, an avatar is a virtual graphical object expressed as graphics that represent a user in the real world, and may be, for example, a two-dimensional (2D) or three-dimensional (3D) icon, character, or model. According to an example embodiment, an avatar may be something as simple as a photo of a user, or may be a graphical object or animation representing the user's appearance, facial expressions, activities, interested matters, or personality. Avatars may be provided through, for example, games, social network services (SNSs), messenger application services, health applications, or exercise applications.

In the present disclosure, ‘mixed reality (MR)’ may refer to a reality in which a virtual image is overlaid or superimposed on a physical environment space or real object in the real world and displayed together, and at the same time a user interacts with a real object and a virtual object.

In the present disclosure, an ‘MR device’ is a device capable of implementing MR, and includes not only MR glasses which are worn on the facial area of a user but also a head mounted display (HMD) or MR helmet which is worn on the head of the user. In this specification, an HMD may be used in a broad sense including MR glasses devices, MR helmets, etc.

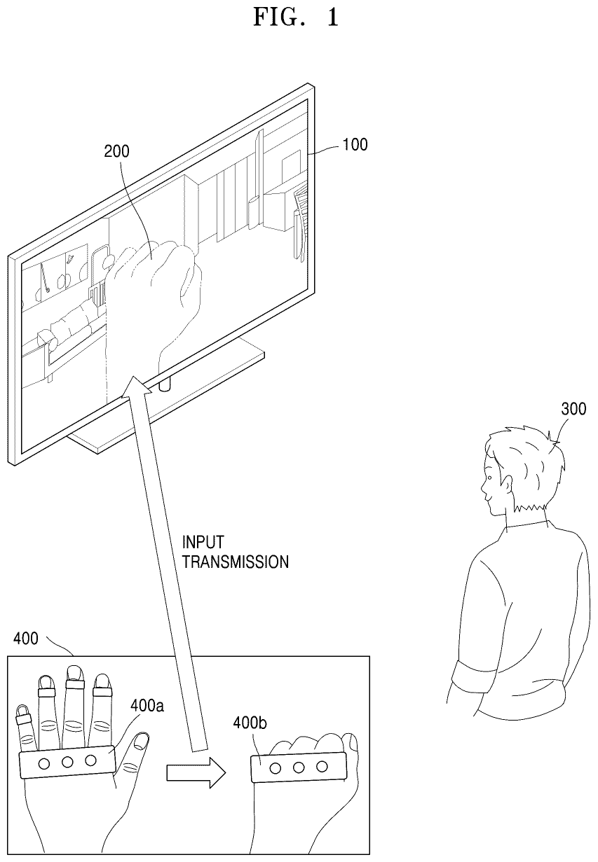

FIG. 1 is a conceptual view of an operation, performed by an electronic device according to an example embodiment, of controlling an avatar.

Referring to FIG. 1, an electronic device 100 may output an MR including an avatar 200 to a user 300.

The electronic device 100 outputting an MR to the user 300 may be an MR device including, for example, a glasses-type MR device, an HMD, and an MR helmet. For example, as illustrated in FIG. 1, the user 300 may view the MR including the avatar 200 through a display-type MR device.

The avatar 200 may refer to a virtual graphical object. The avatar 200 may be expressed in graphics representing a user in the real world. For example, the avatar 200 may include a body part corresponding to the user. As shown in FIG. 1, the avatar 200 may include a graphic in the form of a hand controlled by the user 300.

An external device 400 may include a wearable device that can be worn on the body (e.g., an electronic wristwatch) and a device (e.g., an electronic scale) that obtains a user input through an input means, but the technical spirit of the present disclosure is not limited thereto.

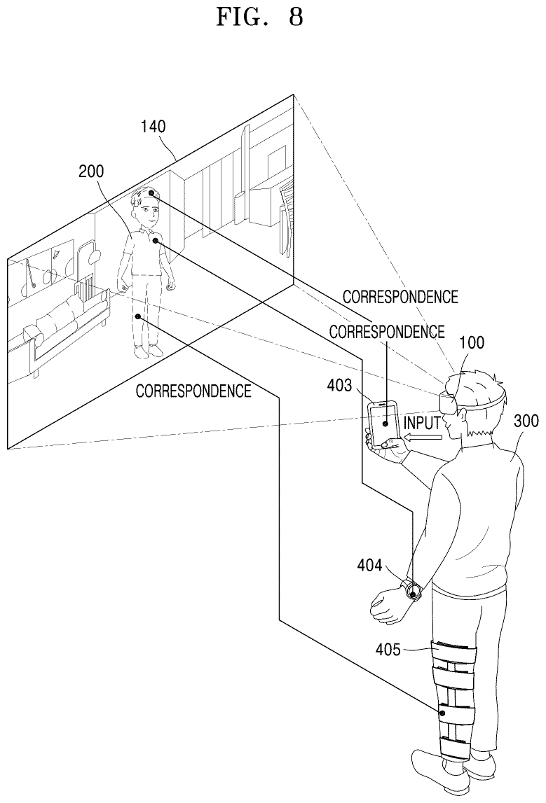

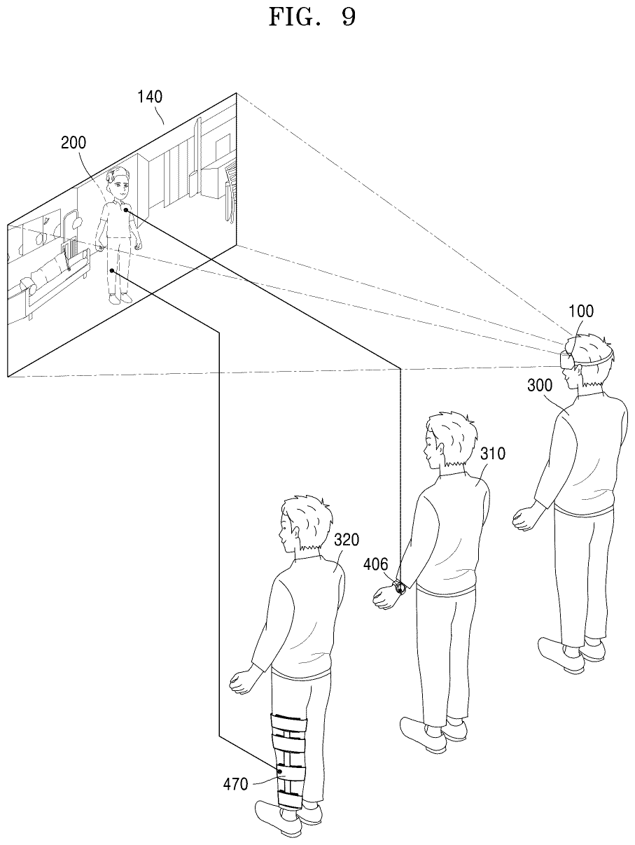

According to an embodiment, the electronic device 100 may obtain sensing information from a plurality of external devices 400. For convenience of explanation, FIG. 1 illustrates one external device. A plurality of external devices will be described in detail using FIGS. 8 and 9. For example, due to occurrence of an action of moving the plurality of external devices 400, the electronic device 100 may obtain sensing information about a motion.

In detail, as illustrated in FIG. 1, a hand of a user wearing the external device 400 may obtain sensing information by performing a motion of changing from a first hand 400a to a second hand 400b. That is, sensing information about a motion of clenching a first may be obtained according to the change from the first hand 400a to the second hand 400b. The electronic device 100 may obtain the sensing information about a motion of clenching a first from the external device 400.

According to an embodiment, the sensing information may include information regarding at least one of a motion, a body state, and a user input. For example, the motion may refer to a motion signal of the external device 400 generated when an external user wearing the external device 400 moves the external device 400. For example, the body state may refer to a heart rate, a blood pressure, a body temperature, an oxygen saturation, electrocardiogram, respiration, pulses, and ballistocardiogram, which may be measured by the external device 400. The body state may also refer to weight, eyesight, hearing, etc. For example, the user input may include information input using an interface displayed through the external device 400 or information detected through a sensor of the external device 400.

According to an embodiment, the electronic device 100 may determine action information, based on the sensing information. The action information may be information about an action that can be implemented by a body part corresponding to the external device 400.

For example, the action information may include information about at least one of an avatar's action and the avatar's body reaction.

In the present disclosure, the action of the avatar 200 may refer to an action that the avatar 200 may take In detail, the action information may include, for example, a walking action of the avatar, an action of the avatar making a specific facial expression, a digging action of the avatar, and an action of the avatar's hand making a fist.

In the present disclosure, the body reaction of the avatar 200 may refer to, for example, the appearance of the avatar expressing a physiological phenomenon. In detail, the action information may include, for example, a yawning action of the avatar and a sweating action of the avatar. As another example, the body reaction of the avatar may also refer to the avatar's appearance expressing changes in the avatar's body state. In detail, the action information may include changes such as an increase in the avatar's height or an increase in the avatar's physique.

According to an embodiment, an electronic device may obtain an action information determination algorithm in memory. The action information determination algorithm may be an algorithm previously set in correspondence with the external device 400. The electronic device 100 may determine the action information corresponding to the obtained sensing information by using the action information determination algorithm.

For example, the external device 400 may be a device for generating sensing information for controlling the avatar 200 in the form of a hand. The external device 400 for controlling the avatar 200 in the form of a hand may be a device wearable on the user's hand, but this does not limit the technical spirit of the present disclosure. For example, the external device 400 generating the sensing information for controlling the avatar 200 in the form of a hand may be a wristwatch-type electronic device that is wearable on the wrist rather than on the hand. As another example, the external device 200 generating the sensing information for controlling the avatar in the form of a hand may be an electronic device such as a controller for obtaining a user input.

In this case, the sensing information obtained by the external device 400 when a user moves his/her hand may correspond to action information for controlling the avatar's hand 200. A correspondence between the sensing information and the action information may be determined by the preset action information determination algorithm. In other words, the electronic device 100 may receive the sensing information obtained by the external device 400 when the user moves his/her hand, and may obtain the action information for controlling the avatar's hand 200, based on the action information determination algorithm.

For example, the external device 400 may be a device for generating the sensing information for controlling the avatar 200 in the form of a hand. As illustrated in FIG. 1, when the user wears the external device 400 on his/her hand and makes a fist, the electronic device 100 may obtain sensing information about a motion of making a first from the external device 400. The electronic device 100 may obtain the action information corresponding to the sensing information about the motion of making a fist, by using the preset action information determination algorithm. An action of the avatar 200 in the form of a hand according to the obtained action information may vary according to the preset action information determination algorithm, but the technical spirit of the present disclosure is not limited thereto. As illustrated in FIG. 1, based on the obtained action information, the avatar 200 in the form of a hand may perform, for example, an action of making a fist.

According to an embodiment, the electronic device 100 may include a display. The electronic device 100 may display the avatar 200 being controlled, through the display. The electronic device 100 may control an action of the avatar 200 to be executed, based on the determined action information. The electronic device 100 may display, through the display, the avatar 200 performing a specific action based on the action information. “Based on” as used herein covers based at least on.

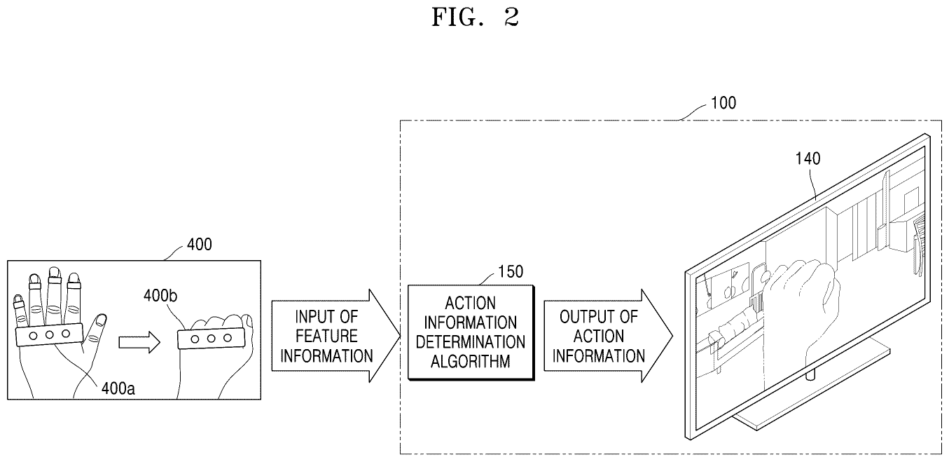

FIG. 2 is a conceptual view illustrating an operation of controlling an avatar, based on the action information output according to the action information determination algorithm, according to an example embodiment. For convenience of explanation, a repeated description of matters described above with reference to FIG. 1 will be given briefly.

Referring to FIG. 2, according to an embodiment, the electronic device 100 may obtain the sensing information from the external device 400. In FIG. 2, the external device 400 is depicted as an electronic device worn on the hand. However, the type of the external device 400 does not limit the technical scope of the present disclosure. The electronic device 100 may obtain the sensing information in various ways, and the electronic device 100 may receive the sensing information from the external device 400.

According to an embodiment, the sensing information may include information regarding at least one of a motion, a body state, and a user input. The sensing information may be obtained through an input means of the external device 400, and may be transmitted to the electronic device 100. For example, due to occurrence of an action of shaking the external device 400, sensing information regarding the shaking motion may be obtained. As another example, when the user's weight is measured by a pressure sensor of the external device 400, sensing information regarding the user's weight input may be obtained. As another example, when the user's heartbeat is measured by a heartbeat measuring sensor of the external device 400, sensing information regarding the user's heartbeat may be obtained. The technical spirit of the present disclosure is not limited regarding a method of obtaining the sensing information of the external device 400.

According to an embodiment, the electronic device 100 may input the sensing information to an action information determination algorithm 150. The electronic device 100 may obtain the action information output in correspondence with the sensing information, by using the action information determination algorithm 150.

The action information determination algorithm 150 may be an algorithm for determining the action information in correspondence with the input sensing information. For example, the sensing information may be information about a hand-waving motion, and the action information determination algorithm 150 may output action information about the avatar 200's hand-waving in correspondence with the sensing information about the hand-waving motion. As another example, the sensing information may be information about a heartbeat measuring value of the user, and the action information determination algorithm 150 may output action information about the avatar 200's panting in correspondence with the sensing information indicating that the heart rate is measured to be 130 beats per minute (bpm) or higher.

According to an embodiment, the action information determination algorithm may be an algorithm for extracting action information, based on type information and sensing information.

The action information determination algorithm may be set based on type information indicating the types of a plurality of external devices 400. For example, sensing information about a fist-clenching motion obtained using a first external device may correspond to action information about the fist-clenching motion. As another example, sensing information about a fist-clenching motion obtained using a second external device may correspond to action information about the avatar's hand-waving motion. The electronic device 100 may store one or more preset action information determination algorithms according to the type of the external device 400, and may obtain action information corresponding to sensing information by using the action information determination algorithm corresponding to the external device 400.

The action information determination algorithm may be set based on the sensing information. For example, sensing information about a fist-clenching motion obtained using the external device 400 may correspond to action information about the fist-clenching motion. As another example, sensing information about a hand-waving motion obtained using the external device 400 may correspond to action information about the avatar's hand-waving motion. The electronic device 100 may store an action information determination algorithm of making respective pieces of action information correspond to various pieces of sensing information with respect to the same external device 400, and may obtain respective pieces of action information corresponding to the various pieces of sensing information obtained from the external device 400, by using the action information determination algorithm.

According to an embodiment, the electronic device 100 may control the avatar 200, based on the determined action information. For example, the action information may include a walking action of the avatar, an action of the avatar making a specific facial expression, and a digging action of the avatar. The electronic device 100 may control the avatar 200 to perform a walking action, based on the action information, or may control the avatar 200 to perform an action of making a specific facial expression.

According to an embodiment, the electronic device 100 may control an action based on the action information to be performed by the avatar 200, through the display.

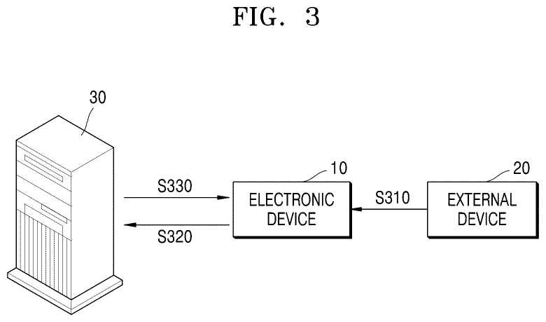

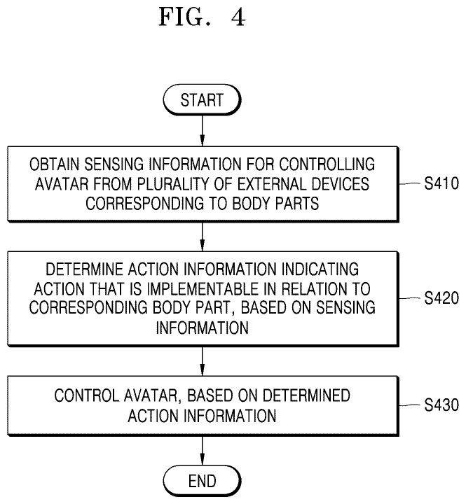

FIG. 3 is a conceptual view for explaining respective roles of subjects played to control an avatar, according to an example embodiment. FIG. 4 is a flowchart of a method, performed by an electronic device, of controlling an avatar, according to an example embodiment.

For convenience of explanation, a repeated description of matters described above with reference to FIGS. 1 and 2 will be given briefly or omitted. FIGS. 3 and 4, which include similar operations, will be described together.

Referring to FIGS. 3 and 4, in operation S310, an electronic device 10 may obtain sensing information from an external device 20. The electronic device 10 may exchange a signal with the external device 20 through a communication interface.

Operation S310 may correspond to operation S410. The electronic device 10 may obtain sensing information for controlling an avatar from a plurality of external devices 20 corresponding to body parts.

In operation S320, the electronic device 10 may transmit the sensing information to a server 30 through the communication interface. In FIG. 3, the electronic device 10 is depicted as exchanging signals with the server 30. However, some or all of the operations of the server 30 may be performed in the electronic device 10.

According to an embodiment, the server 30 may store an action information determination algorithm for converting sensing information into action information. Although the server 30 is depicted as a separate configuration for determining action information, the action information determination algorithm may be stored in a memory of the electronic device 10.

The server 30 may output the action information by inputting the sensing information to the action information determination algorithm. The server 30 may obtain the action information corresponding to the sensing information. In operation S330, the electronic device 10 may receive the action information from the server 30.

According to an embodiment, the server 30 may include a conversion module that converts sensing information generated in a runtime environment of the external device 20 so that the sensing information may be executed in a runtime environment of the electronic device 10. The server 30 may obtain converted sensing information that is recognizable in the runtime environment of the electronic device 10, by using the conversion module. In operation S330, the electronic device 10 may receive the converted sensing information from the server 30. The electronic device 10 may obtain action information, based on the sensing information received from the server 30. As illustrated in FIG. 3, the operation of converting the sensing information may be performed in the separate server 30. However, some or all of the operations of the server 30 may be performed in the electronic device 10.

Operations S320 and S330 may correspond to operation S420. The electronic device 10 may determine action information indicating an action that is implementable in relation to a corresponding body part, based on the sensing information. The electronic device 10 may obtain the action information corresponding to the sensing information by using the action information determination algorithm. As illustrated in FIG. 3, the operation of determining the action information may be performed in the separate server 30. However, some or all of the operations of the server 30 may be performed in the electronic device 10.

In operation S430, the electronic device 10 may control the avatar, based on the determined action information. The electronic device 10 may control a display to display the avatar performing an action based on the action information.

For example, the electronic device 10 may obtain sensing information about a hand-waving motion. The electronic device 10 may obtain action information about a hand-waving motion corresponding to the sensing information about the hand-waving motion, by using the action information determination algorithm. The electronic device 10 may control a hand-waving action of the avatar to be executed, based on the action information.

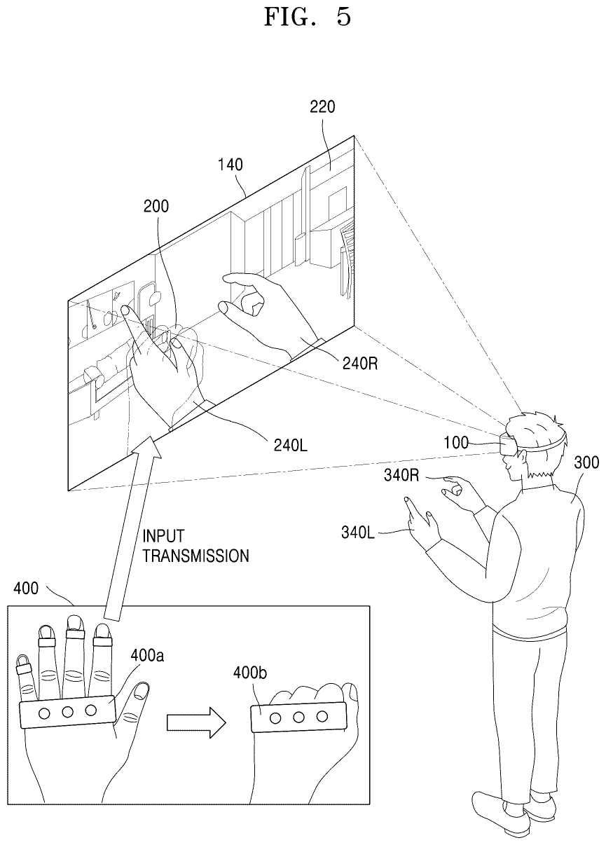

FIG. 5 is a conceptual view for explaining a method, performed by an electronic device worn by a user, for guiding the user's action by controlling an avatar, according to an example embodiment.

For convenience of explanation, a repeated description of matters described above with reference to FIGS. 1 through 4 will be given briefly or omitted.

Referring to FIG. 5, according to an embodiment, the electronic device 100 may be an MR device that is worn by the user 300 to provide an MR to the user 300. The electronic device 100 may include the display 140.

The display 140 illustrated in FIG. 5 is displayed in front of a user only for convenience of explanation, and the technical spirit of the present disclosure is not limited thereto. For example, the display 140 may be positioned as a display within an HMD worn on the head to cover the user's entire field of vision. The display 140 may display a background 220 and the avatar 200.

According to an embodiment, the background 220 may include at least one of a virtual space and a real space. The user 300 may experience a virtual reality in which the avatar 200 is displayed, together with a virtual space, through the display 140. The user 300 may experience an MR in which the avatar 200 is displayed, together with a real space in front of the user, through the display 140. Alternatively, the user 300 may experience an MR in which the avatar 200 is displayed, together with a background on which the virtual space and the real space are both expressed, through the display 140.

According to an embodiment, the electronic device 100 may display a real-world object together with the background 220 and the avatar 200 via the display 140. The real-world object may refer to an actual object that is visible beyond the display of the electronic device 100.

According to an embodiment, the real-world object may include the user's body corresponding to a body part. The electronic device 100 may display the avatar 200 including the body part together with a front image including the user's body corresponding to the body part, through the display 140. The electronic device 100 may display the avatar 200 together with a front image according to the user's field of vision.

For example, the real-world object may include hands 240L and 240R of the user. As illustrated in FIG. 5, hands 340L and 340R of the user may be positioned beyond the display 140 of the electronic device 100. In this case, the electronic device 100 may display the hands 240L and 240R of the user through the display 140. However, the display 140 may refer to a transparent display, and the user's hands 240L and 240R displayed through the display 140 may refer to the user's hands 340L and 340R directly seen by the user 300 beyond the display 140. The technical spirit of the present disclosure is not limited thereto.

As illustrated in the drawings, the electronic device 100 may display the avatar 200 through the display 140, and the user may be guided in body movement by moving a body corresponding to the avatar 200 in comparison with the avatar 200. For example, the user may move his or her body along the trajectory of the avatar 200 displayed by the electronic device 100.

The user 300 may be guided in a action of his or her hand by overlapping the avatar 200 with the user's hands 240L and 240R, through the avatar 200 controlled based on a motion of the external device 400. The electronic device 100 may provide a method of guiding the user to move his or her body in an appropriate manner. The user may receive assistance on how to move his or her own body, based on a motion of the avatar 200.

As illustrated in the drawings, the electronic device 100 may display the avatar 200 corresponding to the user's left hand 240L, and the user 300 may be assisted by moving his or her left hand 240L displayed on the display 140 to overlap the avatar 200. In FIG. 5, only the avatar 200 corresponding to the left hand is displayed. However, this does not limit the technical spirit of the present disclosure, and an avatar corresponding to the right hand may also be displayed.

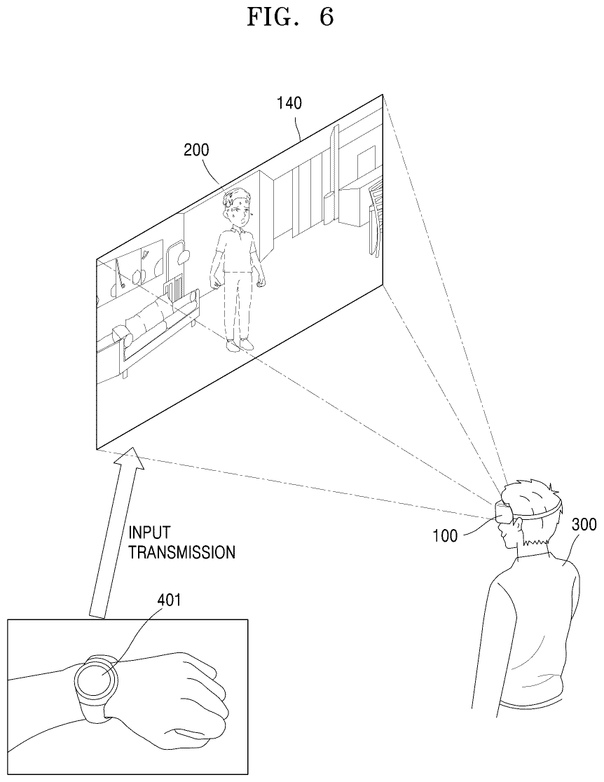

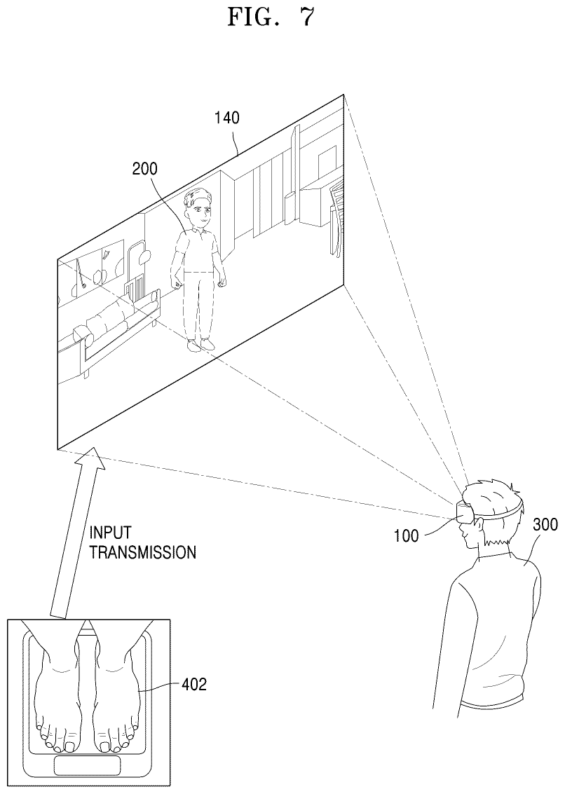

FIGS. 6 and 7 are conceptual views illustrating an operation, performed by an electronic device worn by a user, of controlling an avatar, according to an example embodiment.

For reference, FIGS. 6 and 7 are views for explaining that the avatar 200 may be controlled in various ways according to the type of sensing information that the electronic device 100 receives from the external device 400. For convenience of explanation, a repeated description of matters described above with reference to FIG. 5 will be given briefly or omitted.

Referring to FIGS. 6 and 7, according to an embodiment, the electronic device 100 may obtain sensing information measured by an external device worn by the user. The sensing information may include information regarding at least one of a motion, a body state, and a user input.

The sensing information measured by the external device may vary according to apparatus types. For example, as illustrated in FIG. 6, when an external device 401 is a wristwatch-type external device worn on the wrist, information such as a heart rate, a blood pressure, a body temperature, an oxygen saturation, an electrocardiogram, respiration, pulses, and ballistocardiogram may be measured using a sensor in contact with the wrist. The electronic device 100 may measure, for example, information about a blood pressure, from the wristwatch-type external device 401. The electronic device 100 may obtain sensing information including a body state from the wristwatch-type external device 401.

As another example, the electronic device 100 may receive a user input obtained using an input interface of the wristwatch-type external device 401. In detail, the electronic device 100 may receive a user input for controlling the avatar 200 according to a predetermined action.

As another example, the electronic device 100 may obtain sensing information about a motion by detecting an action of an external user moving while wearing the wristwatch-type external device 401.

As another example, as illustrated in FIG. 7, when an external device 402 is an electronic scale, a person's weight may be measured using a pressure sensor. The electronic device 100 may measure information about the person's weight from the electronic scale 402. The electronic device 100 may obtain sensing information including a body state from the electronic scale 402.

According to an embodiment, the electronic device 100 may determine action information, based on the sensing information. A criterion for determining the action information may vary according to the sensing information and the type of device obtaining the sensing information. The electronic device 100 may determine the action information, based on a preset action information determination algorithm. Since the motion information determination algorithm has been described above in detail using FIG. 2, this is omitted.

For example, information about pulses may be measured using a sensor in contact with the wrist of the wristwatch-type external device 401. The electronic device 100 may obtain sensing information indicating that a pulse is fast, from the wristwatch-type external device 401. The electronic device 100 may control the avatar 200 to sweat by obtaining the sensing information about a rapid pulse, by using an action information determination algorithm that make the sensing information about a rapid pulse correspond to action information about a sweating body state. That is, the electronic device 100 may receive the information indicating that the user's pulse is fast, predict that the user is exercising, and control the avatar 200 to sweat.

However, the action information determination algorithm that make the sensing information about a rapid pulse correspond to the action information about the sweating body state is only an example, and the correspondence relationship between the sensing information and the action information does not limit the technical spirit of the present disclosure. For example, the action information determination algorithm may make the sensing information about a rapid pulse correspond to one of action information about a running exercise, action information about a stressed facial expression, and action information about a pounding heart.

As another example, the electronic device 100 may receive a user input trying to directly control the avatar 200 by using an input interface of the wristwatch-type external device 401. The electronic device 100 may receive, from the external device 401, a user input regarding a direction in which the avatar 200 moves. In response to the user input regarding a direction in which the avatar 200 moves, the electronic device 100 may control the avatar 200 to perform an action of moving in a predetermined direction.

Of course, the method of obtaining, from the external device 401, the user input regarding a direction in which the avatar 200 moves does not limit the technical spirit of the present disclosure. For example, the user input regarding a direction in which the avatar 200 from the external device 401 may be obtained via a motion, or may be obtained via an input through an interface.

As another example, when the external device 402 is an electronic scale, information about a person's weight may be measured using a pressure sensor. The electronic device 100 may obtain, from the electronic scale 402, sensing information indicating that a weight exceeds a standard weight. The electronic device 100 may control the physique of the avatar 200 to greatly change by obtaining sensing information about an excessive weight, by using an action information determination algorithm that makes the sensing information about an excessive weight correspond to action information about changing a body state of the user so that the physique of the avatar enlarges.

As another example, although not shown in the drawings, the external device may be an E-book device, and may obtain information about the user's reading list. The electronic device 100 may obtain the user's reading list as the sensing information through the external device. The electronic device 100 may store an action information determination algorithm that enables an action according to predetermined action information when a reading amount equal to or greater than a reference value is satisfied, based on the user's reading list. The electronic device 100 may control the avatar 200 to perform an action according to predetermined action information when the reading amount equal to or greater than the reference value is satisfied, by using the action information determination algorithm.

For example, when the reading amount equal to or greater than the reference value is satisfied through the external device, the electronic device 100 may grant the avatar 200 the ability to perform a book reading action. The electronic device 100 may control the avatar 200 to read a book by obtaining predetermined sensing information corresponding to action information regarding a book reading action, after the reading amount equal to or greater than the reference value is satisfied. Of course, when the reading amount equal to or greater than the reference value is satisfied through the external device, the electronic device 100 may control the avatar 200 to immediately perform a book reading action, based on corresponding action information.

FIGS. 8 and 9 are conceptual view illustrating an operation, performed by an electronic device, of controlling an avatar by receiving a signal from one or more external devices, according to an example embodiment.

For convenience of explanation, a repeated description of matters described above with reference to FIGS. 1 through 7 will be given briefly or omitted.

Referring to FIG. 8, the electronic device 100 may obtain sensing information for controlling the avatar 200 from a plurality of external devices 403, 404, and 405 corresponding to body parts.

According to an embodiment, the plurality of external devices 403, 404, and 405 may include a first external device 403, a second external device 404, and a third external device 405. In FIG. 8, three external devices are illustrated. However, the number of external devices does not limit the technical spirit of the present disclosure. For example, there may be two or five external devices transmitting sensing information.

According to an embodiment, the plurality of external devices 403, 404, and 405 may be worn by the user 300 who wears the electronic device 100. That is, the user 300 may wear the plurality of external devices 403, 404, and 405 in order to control the avatar 200 displayed through the electronic device 100.

According to an embodiment, the plurality of external devices 403, 404, and 405 may correspond to body parts, respectively. The first external device 403 may correspond to a first part among the body parts. The second external device 404 may correspond to a second part among the body parts. The third external device 405 may correspond to a third part among the body parts. For example, the first external device 403 may correspond to the brain among the body parts, the second external device 404 may correspond to the heart among the body parts, and the third external device 405 may correspond to a leg among the body parts. In detail, the third external device 405 may correspond to a left leg among the legs.

According to an embodiment, the plurality of external devices 403, 404, and 405 may obtain pieces of sensing information to control the avatar 200 in relation to their corresponding body parts, respectively. The electronic device 100 may obtain first sensing information for controlling the avatar 200 in relation to the brain from the first external device 403. The electronic device 100 may obtain second sensing information for controlling the avatar 200 in relation to the heart from the second external device 404. The electronic device 100 may obtain third sensing information for controlling the avatar 200 in relation to the leg from the third external device 405.

According to an embodiment, the electronic device 100 may determine pieces of action information indicating an action that is implementable by a corresponding body part, based on the pieces of sensing information. The electronic device 100 may obtain the pieces of action information corresponding to the pieces of sensing information, based on a preset action information determination algorithm.

The electronic device 100 may determine first action information indicating an action that is implementable in relation to a corresponding brain, based on the first sensing information. For example, the action that is implementable in relation to the brain may refer to a body state change regarding the avatar 200 capability of using a predetermined tool, or may refer to an action of wearing glasses to indicate that the intelligence of the avatar 200 has increased, or may refer to an action of the avatar 200 falling asleep when first sensing information about brain waves during sleep is obtained.

The electronic device 100 may determine second action information indicating an action that is implementable in relation to a corresponding heart, based on the second sensing information. The action that is implementable in relation to the heart may refer to a body change according to a heart state. For example, the action that is implementable in relation to the heart may refer to a body change of sweating when second sensing information about a rapid pulse is obtained, or may refer to a body change of making a dizzy expression in order to make an alarm when second sensing information about low blood pressure is obtained.

The electronic device 100 may determine third action information indicating an action that is implementable in relation to a corresponding leg, based on the third sensing information. For example, the action that is implementable in relation to the leg may include an action of bending the leg, a walking action, a running action, and an action of fine-tuning a leg of the avatar 200 according to a motion of the external device 405 worn on the leg.

According to an embodiment, the electronic device 100 may control the avatar 200, based on each of the pieces of action information respectively corresponding to the plurality of pieces of sensing information obtained from the plurality of external devices 403, 404, and 405. The electronic device 100 may control corresponding body parts of the avatar 200, based on the pieces of action information, respectively.

Referring to FIG. 9, according to an embodiment, a plurality of external devices 406 and 407 may be worn by external users 310 and 320 other than the user 300 who wears the electronic device 100. The plurality of external devices 406 and 407 may be worn by a first external user 310 and a second external user 320, respectively. However, the plurality of external devices 406 and 407 may be worn only by the first external user 310. Alternatively, one of the plurality of external devices 406 and 407 may be worn by the user 300.

That is, the external users 310 and 320 may wear the plurality of external devices 406 and 407 in order to control the avatar 200 displayed to the user 300 through the electronic device 100. The user 300 may view the avatar 200 controlled according to intentions of the external users 310 and 320, through the display 140. The user 300 may be guided in a motion of his/her body by moving his/her body corresponding to the avatar 200 in comparison with the avatar 200.

According to an embodiment, the plurality of external devices 406 and 407 may obtain pieces of sensing information to control the avatar 200 in relation to their corresponding body parts, respectively. The electronic device 100 may obtain first sensing information for controlling the avatar 200 in relation to the heart from the first external device 406. The first external device 406 may be worn by the first external user 310. The electronic device 100 may obtain second sensing information for controlling the avatar 200 in relation to the leg from the second external device 407. The second external device 407 may be worn by the second external user 320.

According to an embodiment, the electronic device 100 may obtain first sensing information when the first external user 310 manipulates the first external device 406. The electronic device 100 may determine first action information, based on the first sensing information. The electronic device 100 may control the avatar 200, based on the first action information. Since controlling an avatar has been explained in detail with reference to FIG. 8, this will be briefly explained.

According to an embodiment, the electronic device 100 may obtain second sensing information when the second external user 320 manipulates the second external device 407. The electronic device 100 may determine second action information, based on the second sensing information. The electronic device 100 may control the avatar 200, based on the second action information. Since controlling an avatar has been explained in detail with reference to FIG. 8, this will be briefly explained.

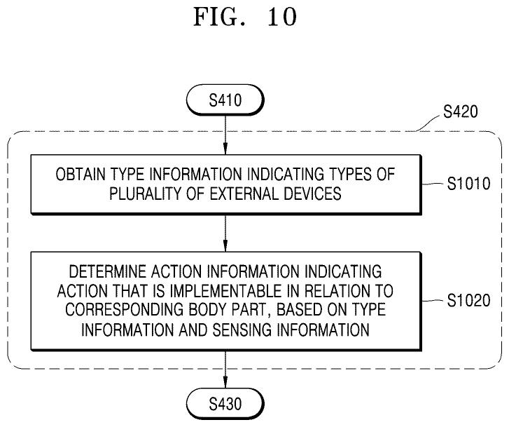

FIG. 10 is a flowchart of a method, performed by an electronic device, of controlling an avatar, according to an example embodiment.

Referring to FIG. 10, according to an embodiment, operation S420 of FIG. 4 may include operations S1010 and S1020.

In operation S1010, the electronic device may obtain type information indicating the types of the plurality of external devices.

According to an embodiment, the electronic device may receive sensing information and the type information from an external device. Since a description of the sensing information has been given above in detail using FIGS. 1 through 9, it is omitted.

The type information may indicate the type of the external device. For example, the plurality of external devices may refer to electronic apparatuses that obtain sensing information that is to be transmitted to the electronic device. The types of the plurality of external devices may refer to the types of electronic apparatuses, such as an eyeglasses-type electronic apparatus worn by a user (or an external user), an HMD, an electronic apparatus worn on the legs by the user (or the external user) to generate a signal related to the legs, and an electronic apparatus that measures a physical condition of the user (or the external user), such as weight, heart rate, or eyesight.

The types of the plurality of external devices may also refer to the types of body parts that correspond to the plurality of external devices. For example, the types of the plurality of external devices may refer to the types of electronic apparatuses respectively corresponding to body parts, such as an electronic apparatus corresponding to the leg, an electronic apparatus corresponding to the heart, an electronic apparatus corresponding to an arm, and an electronic apparatus corresponding to a thumb.

In operation S1020, the electronic device may determine action information indicating an action that is implementable by a corresponding body part, based on the type information and the sensing information.

According to an embodiment, the electronic device may determine action information corresponding to the sensing information, according to a preset action information determination algorithm, based on the type information and the sensing information.

In detail, according to an embodiment, the type information may include information about the type of a first external device and the type of a second external device. Sensing information transmitted from the first external device to the electronic device may include 1_1 sensing information and 1_2 sensing information. Sensing information transmitted from the second external device to the electronic device may include 2_1 sensing information and 2_2 sensing information.

According to an embodiment, the preset action information determination algorithm may make the 1_1 sensing information transmitted by the first external device correspond to 1_1 action information. The preset action information determination algorithm may make the 1_2 sensing information transmitted by the first external device correspond to 1_2 action information. The preset action information determination algorithm may make the 2_1 sensing information transmitted by the second external device correspond to 2_1 action information. The preset action information determination algorithm may make the 2_2 sensing information transmitted by the second external device correspond to 2_2 action information.

According to an embodiment, the electronic device may determine the action information, based on the preset action information determination algorithm. For example, the electronic device may determine the 1_1 action information, based on the type information about the first external device and the 1_1 sensing information received from the first external device. The electronic device may determine the 1_2 action information, based on the type information about the first external device and the 1_2 sensing information received from the first external device. The electronic device may determine the 2_1 action information, based on the type information about the second external device and the 2_1 sensing information received from the second external device. The electronic device may determine the 2_2 action information, based on the type information about the second external device and the 2_2 sensing information received from the second external device.

According to an embodiment, the 1_1 sensing information received from the first external device and the 2_1 sensing information received from the second external device may be different from each other, but may also be the same as each other. For example, the 1_1 sensing information and the 2_1 sensing information may be the same as sensing information regarding an action of drawing a circle. However, even when the 1_1 sensing information and the 2_1 sensing information are the same as each other, the electronic device may determine the 1_1 action information corresponding to the 1_1 sensing information and determine the 2_1 action information corresponding to the 2_1 sensing information, based on the preset motion information determination algorithm. The 1_1 action information and the 2_1 action information may be pieces of information about different actions.

According to an embodiment, the electronic device may control the avatar, based on the determined action information.

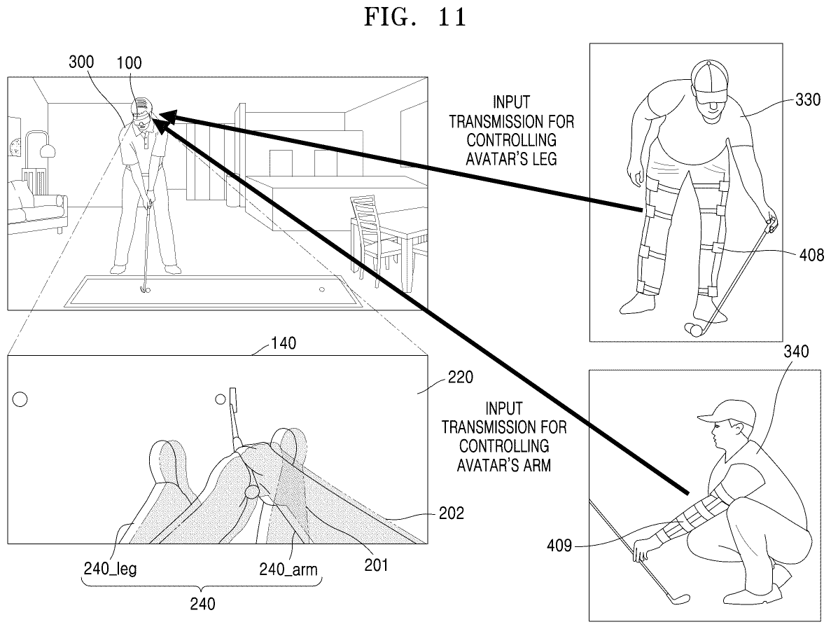

FIG. 11 is a conceptual view of an operation, performed by an electronic device according to an example embodiment, of controlling an avatar. For reference, FIG. 11 is a diagram for explaining an example in which a user experiences an MR through an electronic device according to an embodiment.

For convenience of explanation, a repeated description of matters described above with reference to FIGS. 1 through 10 will be given briefly or omitted.

Referring to FIG. 11, the electronic device 100 may be an MR device that is worn by the user 300 to provide an MR to the user 300. The electronic device 100 may provide the MR to the user 300 through the display 140.

According to an embodiment, the electronic device 100 may provide an MR in which avatars 201 and 202 are displayed, together with a real space in front of the user through the display 140. The electronic device 100 may display the background 220, a real-world object 240, and the avatars 201 and 202 via the display 140.

The background 220 may include a virtual space and a real space.

For example, the background 220 may refer to a real space beyond the display 140 according to the user 300's field of vision. Although not shown in the drawings, when the user 300 looks down at his/her feet after wearing the electronic device 100, the electronic device 100 may display, as the background 220, a real space including the ground on which the user 300 is standing, through the display 140.

As another example, the background 220 may refer to a virtual space created virtually, separate from the real space. As shown in the drawings, when the user 300 looks down at his/her feet after wearing the electronic device 100, the electronic device 100 may display, as the background 220, a virtual space including the ground of a virtual golf course on which the user 300 is standing, through the display 140.

The real-world object 240 may include the user's body seen through the user 300's field of vision. For example, as shown in the drawings, the real-world object 240 may include an arm 240_arm of the user and a leg 240_leg of the user. The user 300 may experience golf within an MR provided through the electronic device 100. A golf ball and a golf club both shown in the drawings may be real-world objects, but may also be virtually created objects. The technical spirit of the present disclosure is not limited thereto.

According to an embodiment, the electronic device 100 may display the avatars 201 and 202 corresponding to the arm 240_arm of the user and the leg 240_leg of the user, through the display 140. The electronic device 100 may display the arm avatar 202 corresponding to the arm 240_arm of the user and the leg avatar 201 corresponding to the leg 240_leg of the user. The arm avatar 202 and the leg avatar 201 may be displayed transparently so as not to obscure the real-world object 240, but the technical spirit of the present disclosure is not limited thereto.

According to an embodiment, the electronic device 100 may display the avatars 201 and 202 corresponding to body parts of the user 300, and may guide an action of the user 300. For example, the user 300 may check the avatars 201 and 202 displayed through the electronic device 100, and the user 300 may adjust his/her own motion by considering motions of the avatars 201 and 202.

For example, the user 300 may move the arm 240_arm of the user along a trajectory of the arm avatar 202 swinging a golf club. That is, the user 300 may be guided in the motion of his/her own arm, based on the motion of the arm avatar 202.

Likewise, the user 300 may move the leg 240_leg of the user according to a posture of the leg avatar 201 positioned to swing a golf club. That is, the user 300 may be guided in the motion of his/her own leg, based on the motion of the leg avatar 201.

According to an embodiment, the electronic device 100 may receive sensing information for controlling the avatars 201 and 202 from external devices 408 and 409. The external devices 408 and 409 may be worn by external users 330 and 340 other than the user 300. The external device may refer to a plurality of external devices, and, as shown in the drawings, may include a first external device 408 and a second external device 409.

The first external device 408 may be worn by a first external user 330. The external device 408 may correspond to a body part. For example, the first external device 480 may be an electronic apparatus that may be worn on the legs of the first external user 330. The first external device 480 may be an electronic apparatus corresponding to legs among the body parts. The first external device 408 may be an electronic apparatus for controlling legs 201 of the avatar.

The second external device 409 may be worn by the second external user 340. The external device 409 may correspond to a body part. For example, the second external device 409 may be an electronic apparatus that may be worn on the arms of the second external user 340. The second external device 409 may be an electronic apparatus corresponding to arms among the body parts. The second external device 409 may be an electronic apparatus for controlling arms 202 of the avatar.

According to an embodiment, the electronic device 100 may control the arm avatar 202, based on first sensing information received by the first external device 408. The electronic device 100 may control the leg avatar 201, based on second sensing information received by the second external device 409. The user 300 may control the motion of the arm 240_arm and the motion of the leg 240_leg, based on the arm avatar 202 and the leg avatar 201 controlled by the electronic device 100. In other words, the user 300 may adjust the motion of the arm 240_arm and the motion of the leg 240_leg according to guides of the first external user 330 and the second external user 340, by using an avatar displaying method provided by the electronic device 100.

However, in FIG. 11, the first external device 408 is described as corresponding to legs among the body parts, and the second external device 409 is described as corresponding to arms among the body parts. However, this is only an example, and the technical spirit of the present disclosure is not limited thereto.

For example, the first external device 408 may correspond to a thumb, and the second external device 409 may correspond to an index finger. The electronic device 100 may provide content that teaches how to use chopsticks by properly controlling each finger, by displaying an avatar expressing a motion of each finger, based on a plurality of pieces of sensing information received from the first external device 408 and the second external device 409.

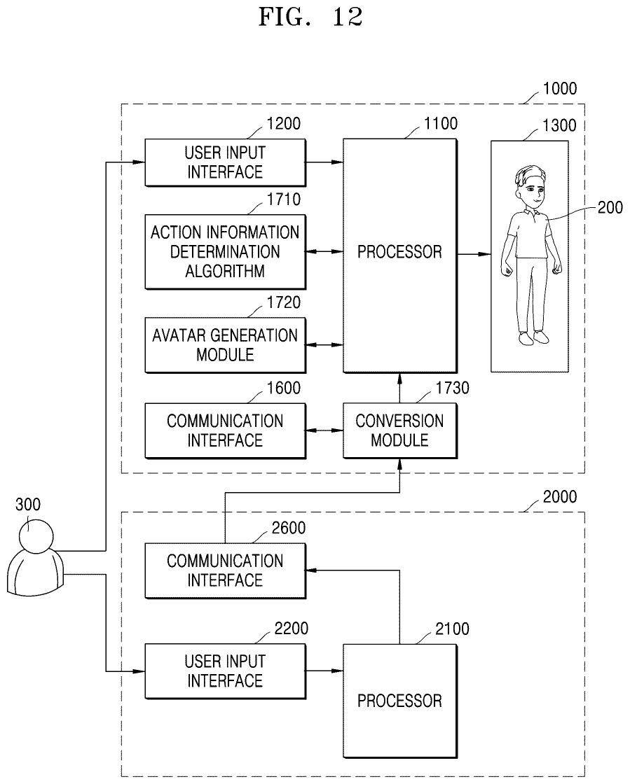

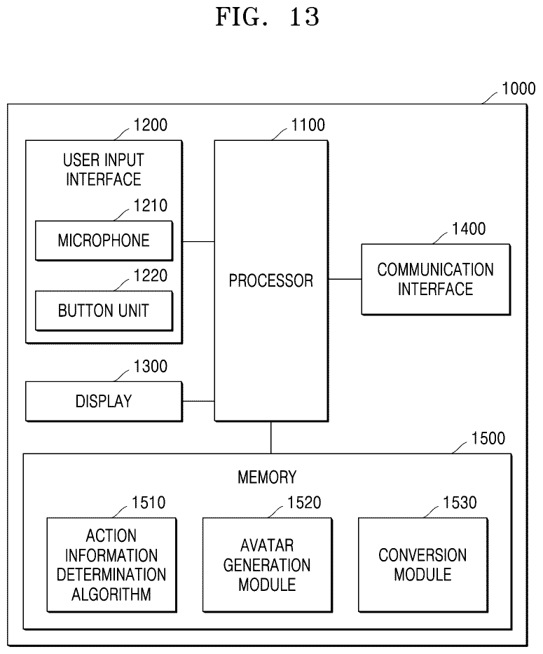

FIG. 12 is a block diagram for explaining an operation, performed by an electronic device according to an example embodiment, of converting sensing information received from an external device. For reference, FIG. 12 mainly describes the operation, performed by the electronic device, of converting sensing information, but a description of each component of the electronic device will be described in detail with reference to FIG. 13.

Referring to FIG. 12, the electronic device 1000 may include a processor 1100, a user input interface 1200, a display 1300, a communication interface 1600, an action information determination algorithm 1710, an avatar generation module 1720, and a conversion module 1730. For reference, the action information determination algorithm 1710, the avatar generation module 1720, and the conversion module 1730 may be stored in a memory 1500 of FIG. 13, and the processor 1100 may perform an operation by using each component stored in the memory.

The external device 2000 may include the processor 1100, the user input interface 1200, and the communication interface 1600. For convenience of explanation, although only minimum components are described, the external device 2000 may include the same configuration as the electronic device 1000. For example, as illustrated in FIG. 13, the external device 2000 may further include a display, an action information determination algorithm, an avatar generation module, and a conversion module.

According to an embodiment, the user 300 may provide a user input via the user input interface 1200. The provided user input may be sensing information for controlling an avatar. The processor 1100 of the external device 2000 may transmit the sensing information obtained by the user input interface 1200 to the electronic device 1000 by using the communication interface 1600. The electronic device 1000 may obtain the sensing information from the external device 2000. The electronic device 1000 may obtain the sensing information from the external device 2000 by using the communication interface 1600.

According to an embodiment, the sensing information obtained from the external device 2000 may refer to a signal recognizable in a runtime environment of the external device 2000. According to the types of electronic apparatuses, respective runtime environments of electronic apparatuses may be different from each other.

For example, a first external device may obtain first sensing information recognizable in a first runtime environment. A second external device may obtain second sensing information recognizable in a second runtime environment. The electronic device may read a signal recognizable in a third runtime environment. The first runtime environment, the second runtime environment, and the third runtime environment may be different from each other.

The electronic device driven in the third runtime environment may not read the first sensing information recognizable in the first runtime environment. The electronic device driven in the third runtime environment may not read the second sensing information recognizable in the second runtime environment.

For example, the runtime environment may be a Windows runtime environment or an Android runtime environment. However, the type of runtime environment is only an example, and the technical spirit of the present disclosure is not limited thereto.

According to an embodiment, because the runtime environment of the external device 2000 and the runtime environment of the electronic device 1000 may be different from each other, the electronic device 1000 may convert the sensing information received from the external device 2000 by using the conversion module 1730. The electronic device 1000 may convert the sensing information received from the external device 2000 so that the sensing information may be read, by using the conversion module 1730.

For example, the electronic device may read a signal recognizable in a third runtime environment. The electronic device 1000 may receive the first sensing information from the first external device through the communication interface 1600. The first sensing information may be information recognizable in the first runtime environment. The electronic device 1000 may convert the first sensing information received from the first external device so that the first sensing information may be recognized in the third runtime environment, by using the conversion module 1730. The method of converting sensing information does not limit the technical idea of the present disclosure.

The electronic device 1000 may receive the second sensing information from the second external device through the communication interface 1600. The second sensing information may be information recognizable in the second runtime environment. The electronic device 1000 may convert the second sensing information received from the second external device so that the second sensing information may be recognized in the third runtime environment, by using the conversion module 1730.

According to an embodiment, the electronic device 1000 may determine information about an action that is implementable in relation to a body part, based on the converted sensing information. The electronic device 1000 may determine the action information corresponding to the sensing information, based on the action information determination algorithm 1710. The electronic device 1000 may determine the action information, based on type information indicating the type of the external device 2000 and the sensing information received from the external device 2000.

According to an embodiment, the electronic device 1000 may control the avatar 200, based on the determined action information.

The electronic device 1000 may generate the avatar 200 by using the avatar generation module 1720. The avatar generation module 1720 may refer to a module for configuring the avatar 200 based on an image of each body part of an avatar and a motion of the body part of the avatar and rendering the avatar 200 on the display. The avatar generation module 1720 may store pieces of information for configuring the avatar 200, such as the shape, wearing, and physical condition of the avatar available by the user 300, and the technical spirit of the present disclosure is not limited thereto.

According to an embodiment, the electronic device 1000 may display the generated avatar 200 on the display 1300. The electronic device 1000 may control the generated avatar 200 to perform a motion based on the action information. The electronic device 1000 may display, for example, a motion performed by the avatar 200, based on data stored in the avatar generation module 1720.

According to an embodiment, the electronic device 1000 may directly receive a user input through the user input interface 1200. The received user input may be sensing information for controlling an avatar. The sensing information directly received by the user input interface 1200 may be recognized in the runtime environment of the electronic device 1000.

According to an embodiment, the electronic device 1000 may determine information about an action that is implementable in relation to a body part, based on the directly received sensing information. The electronic device 1000 may determine the action information corresponding to the sensing information, based on the action information determination algorithm 1710. The electronic device 1000 may determine the action information, based on type information indicating the type of the electronic device 1000 and the sensing information directly received from the electronic device 1000.

According to an embodiment, the electronic device 1000 may control the avatar 200, based on the determined action information. The electronic device 1000 may generate the avatar 200 by using the avatar generation module 1720. The electronic device 1000 may display the generated avatar 200 on the display 1300.

In FIG. 12, the electronic device 1000 and the external device 2000 are expressed separately for convenience of explanation, and the electronic device 1000 and the external device 2000 may not be separated from each other. As described above with reference to FIG. 12, according to an embodiment, the electronic device 1000 may display the avatar 200 through the display 1300 of the electronic device 1000, based on the sensing information received from the external device 2000. According to an embodiment, the electronic device 1000 may display the avatar 200 through the display 1300 of the electronic device 1000, based on the directly-received sensing information. The present disclosure is not limited thereto. According to an embodiment, the external device 2000 may display an avatar through a display (not shown) of the external device 2000, based on the sensing information received from the electronic device 1000. According to an embodiment, the external device 2000 may display the avatar through the display (not shown) of the electronic device 2000, based on the directly-received sensing information.

FIG. 13 is a block diagram of an electronic device according to an example embodiment.

Referring to FIG. 13, the electronic device 1000 according to an example embodiment may include a processor 1100, a user input interface 1200, a display 1300, a communication interface 1400, and a memory 1500.

The user input interface 1200 refers to a unit via which a user inputs data for controlling the electronic device 1000, and may include a microphone 1210 and a button unit 1220.

The microphone 1210 receives an external acoustic signal and converts the external acoustic signal into electrical audio data. For example, the microphone 1210 may receive an acoustic signal from an external device or a speaking person. Various noise removal algorithms may be used to remove noise that is generated while the external acoustic signal is being received via the microphone 1210. The microphone 1210 may receive a user's voice input for controlling the electronic device 1000.

The button unit 1220 may include, but is not limited to, at least one of a key pad, a dome switch, a touch pad (e.g., a capacitive overlay type, a resistive overlay type, an infrared beam type, a surface acoustic wave type, an integral strain gauge type, a piezoelectric type, or the like), a jog wheel, or a jog switch.

The display 1300 displays information that is processed by the electronic device 1000. For example, the display 1300 may display the avatar 200 configured using the avatar generation module 1520. The display 1300 may display a background and a real-world object in addition to the avatar 200.

According to an embodiment, the display 1300 may include a transparent display. When the electronic device 1000 is a device worn on the body, the display 1300 may be disposed to cover the user's field of vision. The display 1300 may display a virtual avatar along with the real space and the real-world object placed in front of the user's field of vision. When the electronic device 1000 is a glasses-type device, the display 1300 may include a left display and a right display.

The communication interface 1600 may transmit/receive data for receiving a service related to the electronic device 1000 to/from an external device (not shown) and a server (not shown). The communication interface 1400 may include one or more components that enable communication between the electronic device 1000 and the server (not shown) and communication between the electronic device 1000 and the external device (not shown). For example, the communication interface 1400 may include a short-range wireless communication interface and a broadcasting receiver.

Examples of the short-range wireless communication interface may include, but are not limited to, a Bluetooth communication interface, a Bluetooth Low Energy (BLE) communication interface, a near field communication (NFC) interface, a wireless local area network (WLAN) (e.g., Wi-Fi) communication interface, a ZigBee communication interface, an infrared Data Association (IrDA) communication interface, a Wi-Fi direct (WFD) communication interface, an ultra wideband (UWB) communication interface, and an Ant+ communication interface.

The communication interface 1400 may obtain sensing information from the external device (not shown). The communication interface 1400 may obtain the sensing information from the external device (not shown) by wire or wirelessly. The external device (not shown) may include, but is not limited to, a server device, a mobile terminal, a wearable device (e.g., a watch, a band, glasses, or a mask), a home appliance (e.g., a TV, a desktop PC, a laptop, a DVD device, a washing machine, or a refrigerator) The memory 1500 may store programs that are to be executed by the processor 1100 to be described later, and may store data input to or output from the external device 1000.

The memory 1500 may include at least one selected from an internal memory (not shown) and an external memory (not shown). The internal memory may include, for example, at least one selected from volatile memory (for example, dynamic RAM (DRAM), static RAM (SRAM), or synchronous dynamic RAM (SDRAM)), non-volatile memory (for example, one time programmable ROM (OTPROM), programmable ROM (PROM), erasable and programmable ROM (EPROM), electrically erasable and programmable ROM (EEPROM), mask ROM, or flash ROM), a hard disk drive (HDD), and a solid state drive (SSD). According to an embodiment, the processor 1100 may load a command or data received from at least one of a non-volatile memory or another element into a volatile memory and process the command or the data. The processor 1100 may store data received from or generated by the other element, in the non-volatile memory. The external memory may include, for example, at least one selected from Compact Flash (CF), Secure Digital (SD), Micro-SD, Mini-SD, extreme Digital (xD) and Memory Stick.

The programs stored in the memory 1500 may be classified into a plurality of modules according to their functions, and may include, for example, a motion information determination algorithm 1510, an avatar generation module 1520, and a conversion module 1530.

The processor 1100 controls all operations of the electronic device 1000. For example, the processor 1100 may entirely control the user input interface 1200, the display 1300, the communication interface 1400, the memory 1500, etc. by executing programs stored in the memory 1500.

The processor 1100 may recognize the sensing information received from the external device, determine action information, and display an avatar on a display, based on the motion information, by executing the motion information determination algorithm 1510, the avatar generation module 1520, and the conversion module 1530 stored in the memory 1500.

According to an embodiment, the electronic device 1000 may include a plurality of processors 1100, and the action information determination algorithm 1510, the avatar generation module 1520, and the conversion module 1530 may be executed by the plurality of processors 1100.

The processor 1100 may convert the sensing information received from the external device, by executing the conversion module 1530 stored in the memory 1500. The sensing information received from the external device may be a signal recognizable in a runtime environment of the external device. The processor 1100 may convert the received sensing information so that the received sensing information may be recognized in the runtime environment of the electronic device 1000, by executing the conversion module 1530.

The sensing information may include information about at least one of a motion of an external user, a physical condition of the external user, and a user input from the external user, which is obtained through the external device (not shown). For example, the sensing information may include information about a motion of drawing a circle through the external device, a motion of making a first through the external device, the user's body weight or heart rate, the user's voice input through the microphone 1210, and a user input through the button unit 1220. The sensing information may be information for controlling an avatar.

The processor 1100 may determine action information corresponding to the sensing information received from the external device, by executing the motion information determination algorithm 1510 stored in the memory 1500. The action information may be information indicating an action that is implementable in relation to a corresponding body part.

According to an embodiment, the action information determination algorithm 1510 may determine action information, based on type information and sensing information. The action information determination algorithm 1510 may determine action information corresponding to the received sensing information. The action information determination algorithm 1510 may determine action information corresponding to predetermined sensing information received from the external device, based on type information representing the type of the external device.

The processor 1100 may generate and control the avatar 200 according to the action information, by executing the avatar generation module 1520 stored in the memory 1500. The avatar generation module 1720 may include data capable of expressing an image and motion of an avatar, and the electronic device 1000 may display an avatar performing a predetermined action by executing the avatar generation module 1720. The electronic device 1000 may display the avatar performing an action based on the action information, by executing the avatar generation module 1720.

Not all of the components illustrated in FIG. 13 are essential components of the electronic device 1000. More or less components than those illustrated in FIG. 13 may constitute the electronic device 1000.

For example, the electronic device 1000 may further include an eye gaze tracking module. The eye gaze tracking module may detect and track the eye gaze of the user wearing the electronic device 1000. The eye gaze tracking module may be installed in a direction toward the user's eyes, and may detect an eye gaze direction of the user's left eye and an eye gaze direction of the user's right eye. Detecting the user's eye gaze direction may include obtaining eye gaze information related to the user's gaze.

Further, the eye gaze information of the user, which is information related to the user's eye gaze, may be generated by analyzing the sensor data and may include, but is not limited to, information about a location of the user's pupil, a location of a pupil central point, a location of the user's iris, centers of the user's eyes, locations of glint feature points of the user's eyes, a gaze point of the user, and an eye gaze direction of the user. The eye gaze direction of the user may be, for example, a direction of the user's eye gaze from the center of the user's eyes toward the gaze point at which the user gazes. For example, the eye gaze direction of the user may be represented by a vector value from the center of the user's left eye toward the gaze point and a vector value from the center of the user's right eye toward the gaze point, but the present disclosure is not limited thereto.

According to an embodiment, the electronic device 1000 may also control the avatar 200 to be displayed at an appropriate location, according to the eye gaze of the user tracked using the eye gaze tracking module.

According to an example embodiment, an electronic device for controlling an avatar may include a communication interface comprising interface circuitry, a memory, and at least one processor comprising processing circuitry. The memory may store one or more instructions. The at least one processor may execute the one or more instructions. The at least one processor may execute the one or more instructions to obtain sensing information for controlling the avatar from a plurality of external devices corresponding to body parts, through the communication interface. The at least one processor may execute the one or more instructions to determine action information indicating an action that is implementable in relation to a corresponding body part, based on the sensing information. The at least one processor may execute the one or more instructions to control the avatar, based on the determined action information.

According to an embodiment, the plurality of external devices may include a first external device and a second external device. The at least one processor may execute the one or more instructions to obtain first sensing information for controlling the avatar from a first external device corresponding to a first part among the body parts. The at least one processor may execute the one or more instructions to obtain second sensing information for controlling the avatar from a second external device corresponding to a second part among the body parts. The at least one processor may execute the one or more instructions to determine first action information indicating an action that is implementable in relation to the first part, based on the first sensing information. The at least one processor may execute the one or more instructions to determine second action information indicating an action that is implementable in relation to the second part, based on the second sensing information. The at least one processor may execute the one or more instructions to control the avatar, based on the first action information and the second action information.

According to an embodiment, the plurality of external devices may be worn by external users. The at least one processor may execute the one or more instructions to receive the sensing information obtained by the plurality of external devices, based on inputs of the external users.

According to an embodiment, the plurality of external devices may include a first external device worn by a first external user and a second external device worn by a second external user. The at least one processor may execute the one or more instructions to receive the first sensing information obtained by the first external device, based on an input of the first external user. The at least one processor may execute the one or more instructions to receive the second sensing information obtained by the second external device, based on an input of the second external user.

According to an embodiment, the sensing information may include information about at least one of a motion of the external user, a physical condition of the external user, and a user input from the external user.

According to an embodiment, the at least one processor may execute the one or more instructions to obtain type information indicating types of the plurality of external devices. The at least one processor may execute the one or more instructions to determine action information indicating an action that is implementable in relation to a corresponding body part, based on the type information and the sensing information.

According to an embodiment, the action information may include information about at least one of an action of the avatar and a physiological response of the avatar.

According to an embodiment, the electronic device may further include a display. The at least one processor may execute the one or more instructions to display the avatar including the body part together with a front image including the user's body corresponding to the body part, through the display.

According to an embodiment, the at least one processor may execute the one or more instructions to obtain sensing information generated in respective runtime environments of the plurality of external devices.

The at least one processor may execute the one or more instructions to convert the sensing information so that the sensing information is executable in a runtime environment of the electronic device. The at least one processor may execute the one or more instructions to determine action information indicating an action that is implementable by a corresponding body part, based on the converted sensing information.

According to an embodiment, the plurality of external devices may include a first external device and a second external device. The at least one processor may execute the one or more instructions to obtain the first sensing information generated in a runtime environment of the first external device. The at least one processor may execute the one or more instructions to obtain the second sensing information generated in a runtime environment of the second external device. The at least one processor may execute the one or more instructions to convert the first sensing information and the second sensing information so that the first sensing information and the second sensing information are executable in the runtime environment of the electronic device. The at least one processor may execute the one or more instructions to determine first action information indicating an action that is implementable in relation to a corresponding body part, based on the converted first sensing information. The at least one processor may execute the one or more instructions to determine second action information indicating an action that is implementable in relation to a corresponding body part, based on the converted second sensing information.

According to an example embodiment, a method of controlling an avatar may include obtaining sensing information for controlling the avatar from a plurality of external devices corresponding to body parts. The method may include determining action information indicating an action that is implementable in relation to a corresponding body part, based on the sensing information. The method may include controlling the avatar, based on the determined action information.

According to an embodiment, the plurality of external devices may include a first external device and a second external device. The obtaining of the sensing information may include obtaining first sensing information for controlling the avatar from the first external device corresponding to a first part among the body parts. The obtaining of the sensing information may include obtaining second sensing information for controlling the avatar from the second external device corresponding to a second part among the body parts. The determining of the action information may include determining first action information indicating an action that is implementable in relation to the first part, based on the first sensing information. The determining of the action information may include determining second action information indicating an action that is implementable in relation to the second part, based on the second sensing information. The controlling of the avatar may include controlling the avatar, based on the first action information and the second action information.

According to an embodiment, the plurality of external devices may be worn by external users. The obtaining of the sensing information may include receiving the sensing information obtained by the plurality of external devices, based on an input of the external user.

According to an embodiment, the plurality of external devices may include a first external device worn by a first external user and a second external device worn by a second external user. The obtaining of the sensing information may include receiving the first sensing information obtained by the first external device, based on an input of the first external user. The obtaining of the sensing information may include receiving the second sensing information obtained by the second external device, based on an input of the second external user.

According to an embodiment, the sensing information may include information about at least one of a motion of the external user, a physical condition of the external user, and a user input from the external user.

According to an embodiment, the determining of the action information may include obtaining type information indicating types of the plurality of external devices. The determining of the action information may include determining action information indicating an action that is implementable in relation to a corresponding body part, based on the type information and the sensing information.

According to an embodiment, the action information may include information about at least one of an action of the avatar and a physiological response of the avatar.

According to an embodiment, the controlling of the avatar may include displaying the avatar including the body part together with a front image including the user's body corresponding to the body part, through a display.

According to an embodiment, the obtaining of the sensing information may include obtaining sensing information generated in respective runtime environments of the plurality of external devices. The obtaining of the sensing information may include converting the sensing information so that the sensing information is executable in a runtime environment of an electronic device. The determining of the action information may include determining action information indicating an action that is implementable by a corresponding body part, based on the converted sensing information.

According to an example embodiment, a computer-readable recording medium has recorded thereon a computer program for performing the above-described method.

The machine-readable storage medium may be provided as a non-transitory storage medium. The ‘non-transitory storage medium’ is a tangible device and only means that it does not contain a signal (e.g., electromagnetic waves). This term does not distinguish a case in which data is stored semi-permanently in a storage medium from a case in which data is temporarily stored. For example, the non-transitory recording medium may include a buffer in which data is temporarily stored.

According to an embodiment, a method according to various disclosed embodiments may be provided by being included in a computer program product. The computer program product, which is a commodity, may be traded between sellers and buyers. Computer program products are distributed in the form of device-readable storage media (e.g., compact disc read only memory (CD-ROM)), or may be distributed (e.g., downloaded or uploaded) through an application store or between two user devices (e.g., smartphones) directly and online. In the case of online distribution, at least a portion of the computer program product (e.g., a downloadable app) may be stored at least temporarily in a device-readable storage medium, such as a memory of a manufacturer's server, a server of an application store, or a relay server, or may be temporarily generated.

While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

1. An electronic device for controlling avatar, the electronic device comprising:
a communication interface comprising circuitry;
a memory storing one or more instructions; and
at least one processor, comprising processing circuitry, configured to execute the one or more instructions, wherein the at least one processor is configured to individually and/or collectively execute the one or more instructions to:
obtain sensing information for controlling the avatar from a plurality of external devices corresponding to user body parts, through at least the communication interface;
determine action information indicating an action that is implementable in relation to a corresponding body part, based on the sensing information; and
control the avatar based on the determined action information.

2. The electronic device of claim 1, wherein
the plurality of external devices include a first external device and a second external device, and
the at least one processor is individually and/or collectively configured to execute the one or more instructions to:
obtain first sensing information for controlling the avatar from a first external device corresponding to a first part among the body parts;
obtain second sensing information for controlling the avatar from a second external device corresponding to a second part among the body parts;
determine first action information indicating an action that is implementable in relation to the first part, based on the first sensing information;
determine second action information indicating an action that is implementable in relation to the second part, based on the second sensing information; and
control the avatar based on the first action information and the second action information.

3. The electronic device of claim 1, wherein
the plurality of external devices are each configured to be worn by an external user, and
the at least one processor is individually and/or collectively configured to execute the one or more instructions to
receive the sensing information obtained by the plurality of external devices based on an input of the external user.

4. The electronic device of claim 3, wherein
the sensing information includes information about at least one of a motion of the external user, a physical condition of the external user, and a user input from the external user.

5. The electronic device of claim 1, wherein
the at least one processor is individually and/or collectively configured to execute the one or more instructions to:
obtain type information indicating types of the plurality of external devices; and
determine action information indicating an action that is implementable in relation to a corresponding body part, based on the type information and the sensing information.

6. The electronic device of claim 1, wherein
the action information includes information about at least one of an action of the avatar and a physiological response of the avatar.

7. The electronic device of claim 1, further comprising
a display,
wherein the at least one processor is individually and/or collectively configured to execute the one or more instructions to
display the avatar including the body part together with a front image including body and/or bodies of a user corresponding to the body part, through the display.

8. The electronic device of claim 1, wherein
the at least one processor is individually and/or collectively configured to execute the one or more instructions to:
obtain sensing information generated in respective runtime environments of the plurality of external devices;
convert the sensing information so that the sensing information is executable in a runtime environment of an electronic device; and
determine action information indicating an action that is implementable by a corresponding body part, based on the converted sensing information.

9. A method of controlling an avatar, the method comprising:
obtaining sensing information for controlling the avatar from a plurality of external devices corresponding to user body parts;
determining action information indicating an action that is implementable in relation to a corresponding body part, based on the sensing information; and
controlling the avatar, based on the determined action information.

10. The method of claim 9, wherein
the plurality of external devices include a first external device and a second external device, and
the obtaining sensing information comprises:
obtaining first sensing information for controlling the avatar from the first external device corresponding to a first part among the body parts; and
obtaining second sensing information for controlling the avatar from the second external device corresponding to a second part among the body parts,
the determining action information comprises:
determining first action information indicating an action that is implementable in relation to the first part, based on the first sensing information; and
determining second action information indicating an action that is implementable in relation to the second part, based on the second sensing information, and
the controlling of the avatars comprises controlling the avatar based on the first action information and the second action information.

11. The method of claim 9, wherein
the determining action information comprises:
obtaining type information indicating types of the plurality of external devices; and
determining action information indicating an action that is implementable in relation to a corresponding body part, based on the type information and the sensing information.

12. The method of claim 9, wherein
the action information includes information about at least one of an action of the avatar and a physiological response of the avatar.

13. The method of claim 9, wherein
the controlling of the avatar comprises
displaying the avatar including the body part together with a front image including bodies of a user corresponding to the body part, via a display.

14. The method of claim 9, wherein
the obtaining sensing information comprises:
obtaining sensing information generated in respective runtime environments of the plurality of external devices; and
converting the sensing information so that the sensing information is executable in a runtime environment of an electronic device, and
the determining of the action information comprises
determining action information indicating an action that is implementable by a corresponding body part, based on the converted sensing information.

15. A computer-readable recording medium having recorded thereon a program, which, when executed by a computer, performs the method of claim 9.
